(19) United States
(12) Patent Application Publication
(10) Pub. No.: US 2013/0111358 A1
(43) Pub. Date: May 2, 2013

(54) SYSTEMS AND METHODS TO PROVIDE SIGNALS REPRESENTATIVE OF DEMAND RESPONSE EVENTS

(71) Applicants: Mark Joseph Meyerhofer, Acworth, GA (US); James Joseph Schmid, Acworth, GA (US); Jerry Steven Massey, Lawrenceville, GA (US); Jaime Alberto Sierra, Atlanta, GA (US)

(72) Inventors: Mark Joseph Meyerhofer, Acworth, GA (US); James Joseph Schmid, Acworth, GA (US); Jerry Steven Massey, Lawrenceville, GA (US); Jaime Alberto Sierra, Atlanta, GA (US)

(21) Appl. No.: 13/283,363

(22) Filed: Oct. 27, 2011

(51) Int. Cl. G06F 3/00

(52) U.S. Cl. 715/753

(57) ABSTRACT

A computing device for use with a demand response system is provided. The computing device includes a processor that is programmed to select a plurality of participants from a plurality of customers to participate in at least one demand response event based on customer data. The processor is also programmed to determine at least one time of day to transmit a plurality of signals representative of the demand response event. The processor is further programmed to transmit, incrementally, the plurality of signals to each of the selected participants such that each of the selected participants receives at least one of the signals.

### BACKGROUND OF THE INVENTION

The field of the invention relates generally to demand response systems and, more particularly, to a computing device for use with a demand response system that enables utilities to selectively provide signals representative of demand response events to its customers.

As the human population increases around the world and with an increase in the use of electric vehicles by customers, energy demand will also likely increase. More specifically, energy demand will likely increase in the form of electrical energy used to power buildings, homes, and/or to charge batteries or other energy sources used in electric vehicles. Moreover, the demand on the power grid is likely to increase while the demand for fuel decreases. Such demands will likely cause an increase in the price of energy from the power grid. In particular, the price of energy is likely to increase during peak times, such as a time of day and/or a day of the week, when demand for energy is high.

Currently, at least some known utilities use demand response systems that enable customers to enroll in at least one demand response program to manage the consumption of energy by their customers in response to supply conditions. Examples of demand response programs include a direct control program, a peak pricing program, such as a critical peak pricing program, and a time of use program. The initiation and/or implementation of a demand response program by a utility is known as a demand response event. A demand response event is initiated by a utility transmitting a plurality of signals to its customers. For example, a demand response event representative of a direct load control program, is initiated when the utility transmits a signal to a device within a building, such as an in-home smart device and/or smart thermostat, such that the utility is enabled to directly control the usage of energy consuming machines within the building. A demand response event representative of a peak pricing program occurs when the utility transmits pricing signals to its customers during peak demand times. The pricing signals enable the utility to apprise customers of heightened energy prices during peak demand time periods such that customers may limit their energy consumption during such peak demand time periods. A demand response event representative of a time of use program occurs when the utility transmits a signal to a customer that is representative of energy prices that correspond to a time range such that the customer may identify an optimal time of day and/or day of the week to consume energy to ensure a low energy price rate.

Such demand response systems enable the utility to manage peak load conditions and to reduce energy demand among its customers. However, current demand response systems transmit signals to all the customers and the signals are transmitted at the same time to the customers, resulting in various problems, such as an increase in load leveling. Moreover, each of the demand response events have a pre-defined start time and/or a pre-defined duration of time for its implementation that a customer may have agreed to with the utility. However, at least some known demand response systems transmit signals representative of demand response events to customers without considering various factors, such as the pre-defined start time and/or the pre-defined duration of time for each demand response event. Signals may be transmitted to customers at incorrect times of the day, resulting in a violation of the various programs that customers may have enrolled in with the utility. Accordingly, an overuse of a certain demand response program may occur and/or the customers may be unnecessarily burdened.

### BRIEF DESCRIPTION OF THE INVENTION

In one embodiment, a computing device for use with a demand response system is provided. The computing device includes a processor that is programmed to select a plurality of participants from a plurality of customers to participate in at least one demand response event based on customer data. The processor is also programmed to determine at least one time of day to transmit a plurality of signals representative of the demand response event. The processor is further programmed to transmit, incrementally, the plurality of signals to each of the selected participants such that each of the selected participants receives at least one of the signals.

In another embodiment, a demand response system is provided. The demand response system includes a computing device and at least one user notification device coupled to the computing device. The computing device includes a processor that is programmed to select a plurality of participants from a plurality of customers to participate in at least one demand response event based on customer data. The processor is also programmed to determine at least one time of day to transmit a plurality of signals representative of the demand response event. The processor is further programmed to transmit, incrementally, the plurality of signals to each of the selected participants such that each of the selected participants receives at least one of the signals. The user notification device enables each of the selected participants to receive the signal.

In yet another embodiment, a method for providing a plurality of signals representative of demand response events is provided. A plurality of participants from a plurality of customers are selected to participate in at least one demand response event based on customer data. At least one time of day to transmit a plurality of signals representative of the demand response event is determined. The signals are transmitted, incrementally, to each of the selected participants such that each of the selected participants receives at least one of the signals.

### BRIEF DESCRIPTION OF THE DRAWINGS

FIG. 1 is a block diagram of an exemplary demand response system;

FIG. 2 is a block diagram of an exemplary computing device that may be used with the demand response system shown in FIGS. 1; and

FIG. 3 is a flow chart of an exemplary method that may be used for providing signals representative of demand response events using the computing device shown in FIG. 2.

### DETAILED DESCRIPTION OF THE INVENTION

The exemplary systems and methods described herein overcome at least some known disadvantages of known demand response systems by enabling a utility to selectively transmit signals representative of demand response events at appropriate times of the day. More specifically, the embodiments described herein provide a computing device for use with a demand response system. The computing device includes a processor that is programmed to select a plurality of participants from a plurality of customers to participate in at least one demand response event based on customer data. The processor is also programmed to determine at least one time of day to transmit a plurality of signals representative of the demand response event. The processor is further programmed to transmit, incrementally, the plurality of signals to each of the selected participants such that each of the selected participants receives at least one of the signals. Accordingly, the utility is able to target specific customers to provide more reliable and substantially greater load reduction. Moreover, by selectively transmitting signals at appropriate times of the day, an overuse of a certain demand response program is prevented and the burden on the customers may be substantially reduced.

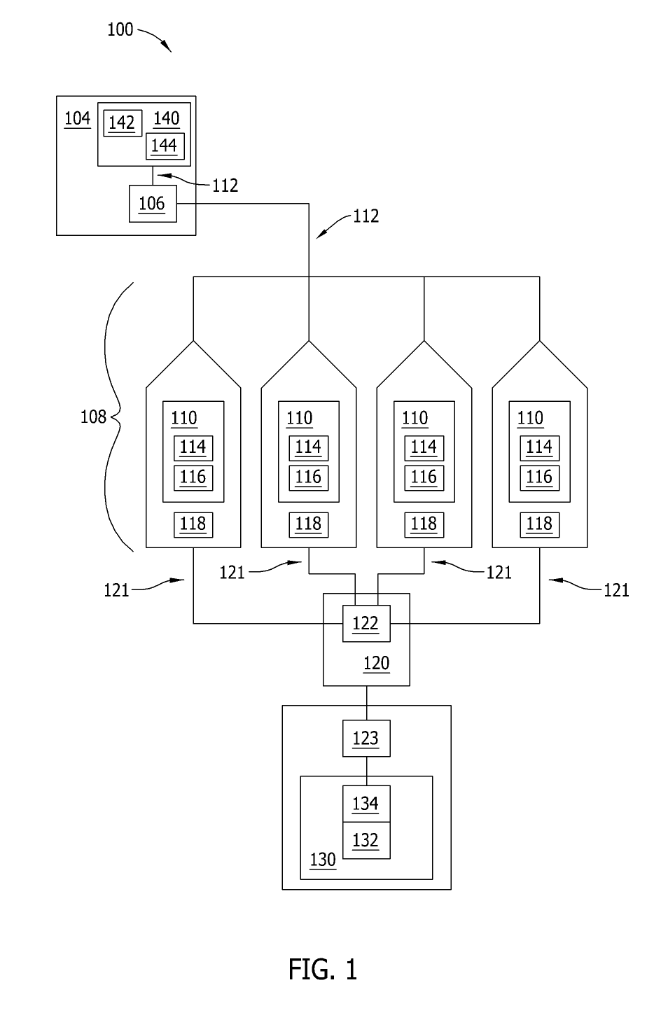

FIG. 1 illustrates a demand response system 100. In the exemplary embodiment, demand response system 100 includes a utility 104 and a computing device 106 positioned within utility 104, wherein computing device 106 enables utility 104 to communicate with customers. Alternatively, computing device 106 may be positioned at another location with respect to utility 104. Moreover, in the exemplary embodiment, computing device 106 is communicatively coupled to a plurality of buildings 108, wherein a plurality of customers may reside. It should be noted that, as used herein, the term “couple” is not limited to a direct mechanical, electrical, and/or communication connection between components, but may also include an indirect mechanical, electrical, and/or communication connection between multiple components.

More specifically, in the exemplary embodiment, computing device 106 is communicatively coupled to at least one user notification device 110 within each building 108 via a network 112 such that computing device 106 may communicate with user notification device 110. In the exemplary embodiment, user notification device 110 may be a computer, a cellular phone, and/or a smart device, including a smart box and/or smart thermostat. Alternatively, user notification device 110 may be any other device that is configured to communicate with computing device 106. In the exemplary embodiment, each user notification device 110 is connected to network 112 and thus, each customer of utility 104 who is the owner and/or user of user notification device 110, has the same network location. Alternatively, each user notification device 110 may be connected to different networks.

Moreover, in the exemplary embodiment, each user notification device 110 includes a user interface 114 that receives at least one input from a user, such as a customer of utility 104. In the exemplary embodiment, user interface 114 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Moreover, in the exemplary embodiment, each user notification device 110 includes a presentation interface 116 that presents information, such as information regarding demand response events that are received from utility 104, input events and/or validation results, to the user. In the exemplary embodiment, presentation interface 116 includes a display adapter (not shown) that is coupled to at least one display device (not shown). More specifically, in the exemplary embodiment, the display device is a visual display device, such as a cathode ray tube (CRT), a liquid crystal display (LCD), an organic LED (OLED) display, and/or an “electronic ink” display. Alternatively, presentation interface 116 may include an audio output device (e.g., an audio adapter and/or a speaker) and/or a printer.

In the exemplary embodiment, computing device 106 may communicate with each user notification device 110 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. WIMAX is a registered trademark of WiMax Forum, of Beaverton, Oreg. IEEE is a registered trademark of the Institute of Electrical and Electronics Engineers, Inc., of New York, N.Y. More specifically, in the exemplary embodiment, user notification device 110 is configured to receive at least one signal from computing device 106 that is representative of at least one demand response event.

In the exemplary embodiment, each building 108 also includes at least one machine 118. Each machine 118, in the exemplary embodiment, consumes energy, such as an appliance and/or a computer. User notification device 110 may or may not be coupled to machine 118. For example, if user notification device 110 is a smart device, then user notification device 110 may be coupled to machine 118, such as an appliance. Moreover, in the exemplary embodiment, each building 108 is coupled to a power distribution substation 120 via a plurality of conduits 121. In the exemplary embodiment, conduits 121 are fabricated from a metallic wire. Alternatively, conduits 121 may be fabricated from any other substance or compound that enables the distribution of electrical energy to each building 108.

More specifically, in the exemplary embodiment, substation 120 includes a grid 122 that is coupled to each building 108 and provides power to each building 108. In the exemplary embodiment, grid 122 is coupled to a generator 123 within a power generation system 124 that is operated by utility 104. In the exemplary embodiment, power generation system 124 includes a machine 130. Machine 130, in the exemplary embodiment, is a variable speed machine, such as a wind turbine, a hydroelectric steam turbine, a gas turbine, and/or any other machine that operates with a variable speed. Alternatively, machine 130 may be a synchronous speed machine. In the exemplary embodiment, machine 130 includes a rotating device 132, such as a rotor or other device. Moreover, in the exemplary embodiment, rotating device 132 rotates a drive shaft 134 that is coupled to generator 123.

In the exemplary embodiment, utility 104 also includes a data management system 140 that is coupled to computing device 106 via network 112. Alternatively, data management system 140 may be separate from utility 104. Data management system 140 may be any device capable of accessing network 112 including, without limitation, a desktop computer, a laptop computer, or other web-based connectable equipment. More specifically, in the exemplary embodiment, data management system 140 includes a database 142 that includes customer data for each of the customers of utility 104. In the exemplary embodiment, database 142 can be fully or partially implemented in a cloud computing environment such that data from the database is received from one or more computers (not shown) within utility 104 or remote from utility 104. The customer data includes information for each customer. For example, the customer data includes a location for each customer, such as a geographic location where each customer resides, a location on network 112 for each customer, and/or a location for substation 120 for each customer. The customer data may also include an enrollment status for each customer for participating in at least one demand response program. In the exemplary embodiment, the demand response programs may include a direct load control program, a peak pricing program, such as a critical peak pricing program, and/or a time of use program. For example, the data may include a selection made by each customer for at least one demand response program to participate in. The customer data may also include at least one demand response program selected by each customer for each machine 118 to participate in. Moreover, in the exemplary embodiment, the customer data may include a pre-defined duration of time for at least one demand response event, which includes the implementation of each demand response program that each customer has agreed to and/or elected to participate in. The data may also include a pre-defined start time for the demand response event. For example, a customer may have elected to participate in a direct load control program that is implemented every day at 5:00 p.m. for sixty minutes. Similarly, another customer may have elected to participate in a peak pricing program that is implemented every day at 3:00 p.m. for thirty minutes.

Moreover, in the exemplary embodiment, data management system 140 includes a user interface 144 that receives at least one input from a user, such as an operator and/or employee of utility 104. In the exemplary embodiment, data management system user interface 144 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Data management system 140 may communicate with computing device 106 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. More specifically, in the exemplary embodiment, data management system 140 transmits the customer data to computing device 106. While the customer data is shown as being stored in database 142 within data management system 140 in the exemplary embodiment, it should be noted that the customer data may be stored in another system and/or device. For example, computing device 106 may store the customer data therein.

During operation, utility 104 may transmit, for example, a questionnaire to its customers via computing device 106. The questionnaire provides questions to each customer to answer regarding the customer and the questionnaire provides various demand response programs that each customer may elect to participate in. More specifically, in the exemplary embodiment, the questionnaire is transmitted to user notification device 110. Each customer may input various responses to the questionnaire via user interface 114 within user notification device 110, including selecting at least one demand response program to participate in and/or selecting at least one demand response program for machine 118 to participate in. Each customer may also specify their location, such as where each customer is geographically located, a location on a network for each customer, and a location of substation 120 for each customer. Alternatively, utility 104 may provide such a questionnaire to its customers via other means. For example, utility 104 may send the questionnaire via mail. Moreover, customers may provide responses for the questionnaire to utility 104 via other means, as opposed to via user notification device 110.

In the exemplary embodiment, if a customer provides his or her responses via user notification device 110, then the information that the customer provides is transmitted to computing device 106 via network 112. Computing device 106 then transmits the information to data management system 140, wherein the data is stored in database 142. If a customer provides his or her responses via other means, utility 104 may receive the information and input the data to data management system 140 via data management system user interface 144, wherein the data may be stored in database 142.

When utility 104 needs to transmit notification of a demand response event to a customer, a user may input customer names and an initiation and/or implementation of a demand response event to computing device 106 at a particular time such that computing device 106 may transmit the signals representative of at least one demand response event to the customers identified by the user.

Alternatively, computing device 106 may be programmed to select participants and to determine at least one time of day to transmit the signals representative of at least one demand response event. More specifically, in the exemplary embodiment, computing device 106 receives customer data from database 142 and selects a plurality of participants from the customers for participating in at least one demand response event based on the customer data received. Computing device 106 then determines at least one time of day to transmit a plurality of signals representative of the demand response event. Then computing device 106 incrementally transmits the plurality of signals to each selected participant such that each participant receives at least one of the plurality of signals at the determined times. For example, thirty percent of the selected participants may receive the signal first, and then another thirty percent of the selected participants may receive the signal fifteen minutes later until all the selected participants have received the signal. Moreover, in the exemplary embodiment, each selected participant receives the signal of a demand response event via user notification device 110. For example, if a selected participant selected to participate in a peak pricing program, pricing signals will be transmitted to the participant during the appropriate peak demand times via user notification device 110.

By selectively identifying participants and by transmitting staggered signals to the participants selected, as opposed to all the customers, utility 104 is able to target specific customers and/or locations on grid 122 to reduce the chances for a failure of grid 122 and there may be a reduction in load leveling. Moreover, by selectively transmitting signals to only selected participants, an overuse of a certain demand response program is prevented and the burden on the customers may be substantially reduced.

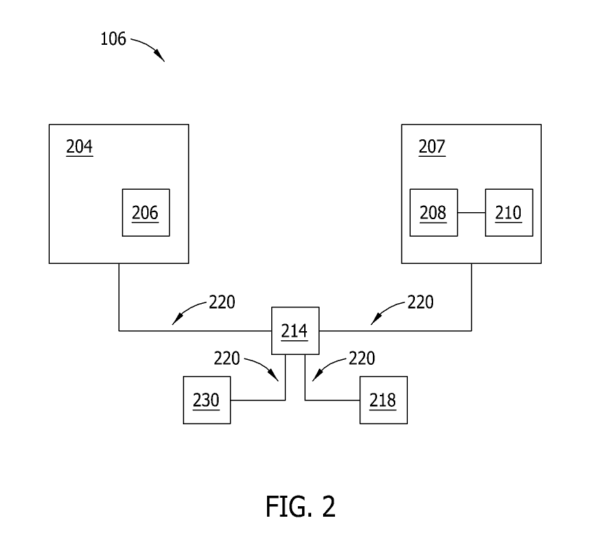

FIG. 2 is a block diagram of computing device 106. In the exemplary embodiment, computing device 106 includes a user interface 204 that receives at least one input from a user, such as an operator and/or employee of utility 104 (shown in FIG. 1). In the exemplary embodiment, user interface 204 includes a keyboard 206 that enables the user to input pertinent information. Alternatively, user interface 204 may include, for example, a pointing device, a mouse, a stylus, a touch sensitive panel (e.g., a touch pad or a touch screen), a gyroscope, an accelerometer, a position detector, and/or an audio input interface (e.g., including a microphone).

Moreover, in the exemplary embodiment, computing device 106 includes a presentation interface 207 that presents information, such as input events and/or validation results, to the user. In the exemplary embodiment, presentation interface 207 includes a display adapter 208 that is coupled to at least one display device 210. More specifically, in the exemplary embodiment, display device 210 is a visual display device, such as a cathode ray tube (CRT), a liquid crystal display (LCD), an organic LED (OLED) display, and/or an “electronic ink” display. Alternatively, presentation interface 207 may include an audio output device (e.g., an audio adapter and/or a speaker) and/or a printer.

Computing device 106 also includes a processor 214 and a memory device 218. In the exemplary embodiment, processor 214 is coupled to user interface 204, presentation interface 207, and to memory device 218 via a system bus 220. In the exemplary embodiment, processor 214 communicates with the user, such as by prompting the user via presentation interface 207 and/or by receiving user inputs via user interface 204. Moreover, in the exemplary embodiment, processor 214 is programmed by encoding an operation using one or more executable instructions and providing the executable instructions in memory device 218. For example, processor 214 is programmed to select a plurality of participants from the customers for participating in least one demand response event. More specifically, in the exemplary embodiment, processor 214 is programmed to select the participants by considering the customer data, such as the location for each customer, the type of at least one demand response program that each customer has selected to participate in, and/or the type of at least one demand response program that each customer has selected machine 118 (shown in FIG. 1) to participate in. Alternatively, processor 214 may select the participants by considering any other information about each customer that enables computing device 106 and/or demand response system 100 (shown in FIG. 1) to function as described herein.

Moreover, in the exemplary embodiment, processor 214 is programmed to determine at least one time of day to transmit a plurality of signals that are each representative of the demand response event to the selected participants. Processor 214 makes the determination based on various factors. For example, processor 214 is programmed to calculate a total numeric value of the plurality of selected participants and processor may determine the time of day to transmit the signals based on the total numeric value. Moreover, processor 214 is further programmed to identify a pre-defined duration of time for a demand response event based on the customer data received. Similarly, based on the customer data received, processor 214 is programmed to identify a pre-defined start time that each participant agreed to and/or elected to participate in for at least one demand response event. Processor 214 may determine the time of day to transmit the signals by considering the pre-defined duration of time and/or the pre-defined start time. Processor 214 may also determine the time of day to transmit the signals by considering a type of demand response program each participant enrolled in and/or elected to have machine 118 enroll in.

Processor 214, in the exemplary embodiment, is further programmed to incrementally transmit the plurality of signals to each selected participant such that each selected participant receives at least one signal. When processor 214 has determined the time of day that signals should be transmitted, processor 214 may transmit the signals based on the determined time. For example, processor 214 may organize the selected participants in a hierarchy and/or particular order, and processor 214 is programmed to incrementally transmit the signals based on the hierarchy and/or order. For example, processor 214 may be programmed to organize at least one participant who resides in a particular geographic location and is enrolled in a peak pricing program with a pre-defined start time of 2:00 p.m. for a duration of twenty minutes in a first tier of the hierarchy and organize at least one participant who resides in a different geographic location and is enrolled in a time of use program with a pre-defined start time of 2:30 p.m. for a duration of twenty minutes in a second tier of the hierarchy. Processor 214 may first transmit the signals to the participants in the first tier of the hierarchy, and then transmit the signals to the participants in the second tier of the hierarchy thirty minutes after the first set of signals have been transmitted.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by a user via user interface 204, and/or information received from other components of demand response system 100 (shown in FIG. 1), such as from user notification device 110 (shown in FIG. 1) and/or data management system 140 (shown in FIG. 1).

Computing device 106, in the exemplary embodiment, also includes a communication interface 230 that is coupled to processor 214 via system bus 220. Moreover, in the exemplary embodiment, communication interface 230 is communicatively coupled to user notification device 110 and data management system 140 via network 112 (shown in FIG. 1). In the exemplary embodiment, communication interface 230 communicates with user notification device 110, data management system 140, and/or other components within system 100.

During operation, utility 104 may transmit, for example, a questionnaire to its customers via computing device 106. The questionnaire provides questions to each customer to answer regarding the customer and the questionnaire provides various demand response programs that each customer may elect to participate in. More specifically, in the exemplary embodiment, the questionnaire is transmitted to user notification device 110. Each customer may input various responses to the questionnaire via user interface 114 (shown in FIG. 1) within user notification device 110, including selecting at least one demand response program to participate in and/or selecting at least one demand response program to have machine 118 participate in. Each customer may also specify their location, such as where each customer is geographically located, a location on a network for each customer, and a location for substation 120 for each customer. Alternatively, utility 104 may provide such a questionnaire to its customers via other means. For example, utility 104 may send the questionnaire via mail. Moreover, customers may provide responses for the questionnaire to utility 104 via other means, as opposed to via user notification device 110.

In the exemplary embodiment, if a customer provides his or her responses via user notification device 110, then the information that customer provides is transmitted to computing device 106 via network 112. Computing device then transmits the information to data management system 140, wherein the data is stored in database 142 (shown in FIG. 1). If a customer provides his or her responses via other means, utility 104 may receive the information and input the data to data management system 140 via user interface 144 (shown in FIG. 1), wherein the data may be stored in database 142.

When utility 104 needs to notify some of its customers regarding a demand response event, a user may input customer names and an initiation and/or implementation of a demand response event to computing device 106 at a particular time such that computing device 106 may transmit the signals representative of at least one demand response event to the customers identified by the user.

Alternatively, computing device 106 may be programmed to select participants and to determine at least one time of day to transmit the signals representative of at least one demand response event. More specifically, in the exemplary embodiment, processor 214 transmits a signal via communication interface 230 to data management system 140 to retrieve customer data from database 142. Customer data is transmitted from database 142 to computing device 106, wherein communication interface 230 receives the data and transmits the data to processor 214. Processor 214 selects and identifies a plurality of participants of the customers for participating in at least one demand response event. More specifically, in the exemplary embodiment, processor 214 selects the participants by considering at least the location for each customer, the type of demand response program that each customer has selected to enroll or participate in, and/or the type of demand response program that each customer has selected machine 118 to enroll or participated in. Alternatively, processor 214 may select the participants by considering any other information about each customer that enables computing device 106 and demand response system 100 to function as described herein.

Processor 214 then determines at least one time of day to transmit a plurality of signals that are each representative of at least one demand response event to the selected participants. In the exemplary embodiment, processor 214 determines the time of day to transmit the signals by considering various factors. For example, processor 214 calculates a total numeric value of the plurality of selected participants. Moreover, based on the customer data received, processor 214 identifies a pre-defined duration of time and/or a pre-defined start time that each participant agreed to and/or elected to participate in for at least one demand response event. In the exemplary embodiment, processor 214 then determines the time of day to transmit the signals by considering the total numeric value of the selected participants, the pre-defined duration of time and/or the pre-defined start time. Processor 214 also determines the time of day to transmit the signals by considering a type of demand response program that each participant elected to enroll or participate in and/or elected to have machine 118 enroll or participate in.

When processor 214 has selected the time of day to transmit the signals, processor 214 then incrementally transmits the signals to the selected participants such that each of the selected participants receives at least one signal. More specifically, in the exemplary embodiment, processor 214 organizes the selected participants in a hierarchy and/or particular order, and processor 214 incrementally transmits the signals based on the hierarchy. For example, processor 214 may organize at least one participant who resides in a particular geographic location and who is enrolled in a peak pricing program with a pre-defined start time of 2:00 p.m. for a duration of twenty minutes in a first tier of the hierarchy and organize at least one participant who resides in a different geographic location and who is enrolled in a time of use program with a pre-defined start time of 2:30 p.m. for a duration of twenty minutes in a second tier of the hierarchy. In the exemplary embodiment, processor 214 transmits the signals first to the participants in the first tier of the hierarchy at 2:00 p.m. Processor 214 then transmits the signals to the participants in the second tier of the hierarchy thirty minutes later. Accordingly, in the exemplary embodiment, selected participants who reside in one geographic area and who are in enrolled in a certain demand response program may receive the signal before selected participants who live in another geographic location and who are enrolled in a different demand response program.

Moreover, in the exemplary embodiment, each selected participant receives the signal of the demand response event via user notification device 110. For example, if a selected participant elected to participate in a peak pricing program, pricing signals will be transmitted to the participant during the appropriate peak demand times via user notification device 110.

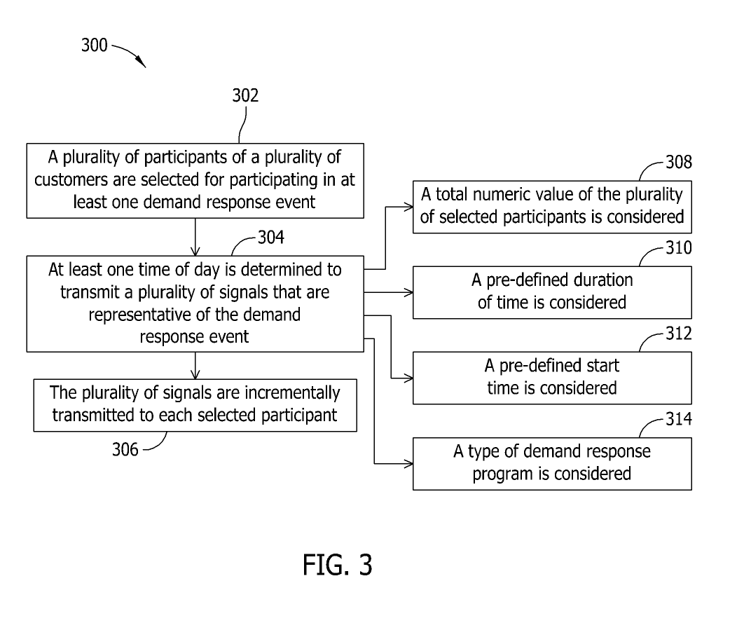

FIG. 3 is a flow chart of a method 300 that may be used for providing a plurality of signals representative of demand response events using a computing device, such as computing device 106 (shown in FIGS. 1 and 2). A plurality of participants are selected 302 from a plurality of customers for participating in at least one demand response event based on customer data. At least one time of day is determined 304, via a processor 214 (shown in FIG. 2), to transmit a plurality of signals that are representative of the demand response event to the selected participants. The plurality of signals are incrementally transmitted 306 to each of the selected participants such that each participant receives at least one of the plurality of signals.

When the time of day is determined 304, a total numeric value of the plurality of selected participants is considered 308 by processor 214. Moreover, a pre-defined duration of time for the demand response event is considered 310. A pre-defined start time that each participant selected to enroll in for the demand response event is also considered 312. Further, a type of demand response program that the selected participants selected to enroll in and/or have machine 118 (shown in FIG. 1) enroll in is considered 314.

As compared to known demand response systems that are used to enable utilities to manage energy consumption by the implementation of demand response events, the exemplary systems and methods described herein enable a utility to selectively transmit signals representative of the implementation of demand response events at appropriate times of the day. More specifically, the embodiments described herein provide a computing device for use with a demand response system. The computing device includes a processor that is programmed to select a plurality of participants from a plurality of customers to participate in at least one demand response event based on customer data. The processor is also programmed to determine at least one time of day to transmit a plurality of signals representative of the demand response event. The processor is further programmed to transmit, incrementally, the plurality of signals to each of the selected participants such that each of the selected participants receives at least one of the signals. Accordingly, the utility is able to target specific customers to provide more reliable and substantially greater load reduction. Moreover, by selectively transmitting signals at appropriate times of the day, an overuse of a certain demand response program is prevented and the burden on the customers may be substantially reduced.

A technical effect of the systems and methods described herein includes at least one of: (a) selecting a plurality of participants from a plurality of customers to participate in at least one demand response event based on customer data; (b) determining at least one time of day to transmit a plurality of signals representative of at least one demand response event; and (c) transmitting, incrementally, a plurality of signals to each of a plurality of selected participants such that each of the plurality of selected participants receives at least one of the plurality of signals.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for use with a demand response system, said computing device comprising a processor programmed to:
select a plurality of participants from a plurality of customers to participate in at least one demand response event based on customer data;
determine at least one time of day to transmit a plurality of signals representative of the at least one demand response event; and
transmit, incrementally, the plurality of signals to each of the plurality of selected participants such that each of the plurality of selected participants receives at least one of the plurality of signals.

2. A computing device in accordance with claim 1, wherein said processor is further programmed to calculate a total numeric value of the plurality of selected participants, said processor is programmed to determine the at least one time of day based on the total numeric value.

3. A computing device in accordance with claim 1, wherein said processor is further programmed to identify a pre-defined duration of time for the at least one demand response event, said processor is programmed to determine the at least one time of day based on the pre-defined duration of time.

4. A computing device in accordance with claim 1, wherein said processor is further programmed to identify a pre-defined start time for the at least one demand response event, said processor is programmed to determine the at least one time of day based on the pre-defined start time.

5. A computing device in accordance with claim 1, further comprising a communication interface configured to receive the customer data.

6. A computing device in accordance with claim 1, wherein said processor is programmed to select the plurality of participants to participate in the at least one demand response event based at least in part on at least one demand response program that each of the plurality of customers selected to enroll in, the at least one demand response program includes at least one of a direct load control program, a peak pricing program, and a time of use program.

7. A computing device in accordance with claim 6, wherein said processor is programmed to determine the at least one time of day based at least in part in a type of the at least one demand response program.

8. A demand response system comprising:
a computing device comprising a processor programmed to:
select a plurality of participants from a plurality of customers to participate in at least one demand response event based on customer data;
determine at least one time of day to transmit a plurality of signals representative of the at least one demand response event; and
transmit, incrementally, the plurality of signals to each of the plurality of selected participants such that each of the plurality of selected participants receives at least one of the plurality of signals; and
at least one user notification device coupled to said computing device to enable each of the plurality of selected participants to receive the at least one of the plurality of signals.

9. A demand response system in accordance with claim 8, wherein said at least one user notification device is at least one of a phone, a computer system, and a smart device.

10. A demand response system in accordance with claim 8, further comprising a data management system coupled to said computing device, wherein said data management system is configured to the store customer data therein and to transmit the customer data to said computing device.

11. A demand response system in accordance with claim 8, wherein said processor is further programmed to calculate a total numeric value of the plurality of selected participants, said processor is programmed to determine the at least one time of day based on the total numeric value.

12. A demand response system in accordance with claim 8, wherein said processor is further programmed to identify a pre-defined duration of time for the at least one demand response event, said processor is programmed to determine the at least one time of day based on the pre-defined duration of time.

13. A demand response system in accordance with claim 8, wherein said processor is further programmed to identify a pre-defined start time for the at least one demand response event, said processor is programmed to determine the at least one time of day based on the pre-defined start time.

14. A demand response system in accordance with claim 8, wherein said processor is programmed to select the plurality of participants to participate in the at least one demand response event based at least in part on at least one demand response program that each of the plurality of customers selected to enroll in, the at least one demand response program includes at least one of a direct load control program, a peak pricing program, and a time of use program, said processor is programmed to determine the at least one time of day based at least in part in a type of the at least one demand response program.

15. A method for providing a plurality of signals representative of demand response events, said method comprising:
selecting a plurality of participants from a plurality of customers to participate in at least one demand response event based on customer data;
determining at least one time of day to transmit a plurality of signals representative of the at least one demand response event; and
transmitting, incrementally, the plurality of signals to each of the plurality of selected participants such that each of the plurality of selected participants receives at least one of the plurality of signals.

16. A method in accordance with claim 15, wherein determining at least one time of day further comprises determining at least one time of day based on a total numeric value of the plurality of selected participants.

17. A method in accordance with claim 15, wherein determining at least one time of day further comprises determining at least one time of day based on a pre-defined duration of time for the at least one demand response event.

18. A method in accordance with claim 15, wherein selecting a plurality of participants further comprises selecting a plurality of participants based at least in part on at least one demand response program that each of the plurality of customers enrolled in, the at least one demand response program includes at least one of a direct load control program, a peak pricing program, and a time of use program.

19. A method in accordance with claim 18, wherein determining at least one time of day further comprises determining at least one time of day based on a type of the at least one demand response program.

20. A method in accordance with claim 15, wherein determining at least one time of day further comprises determining at least one time of day based on a pre-defined start time for the at least one demand response event.
